(19) United States
(12) Patent Application Publication
(10) Pub. No.: US 2026/0296905 A1
(43) Pub. Date: Oct. 1, 2026

(54) METHOD FOR PRODUCING LOW-CARBON AMMONIA FROM NATURAL GAS

(71) Applicant: Publichnoe Aktsionernoe Obshchestvo "NOVATEK", Tarko-Sale (RU)

(72) Inventors: Aleksandr Iurevich UGLOV, Moscow (RU); Stanislav Aleksandrovich NIKULIN, Moscow (RU); Sergei Vladimirovich RUDENKO, Moscow (RU); Dmitrii Nikolaevich SEDAVNYKH, Moscow (RU); Vladimir Nikolaevich LEPSKII, Moscow (RU); Anna Aleksandrovna DUROVA, Moskovskaya obl., g. Dubna (RU); Aleksei Rafailevich AKHMETSHIN, Moscow (RU); Igor Aleksandrovich SHLIAPIN, Moscow (RU)

(73) Assignee: Publichnoe Aktsionernoe Obshchestvo "NOVATEK", Tarko-Sale (RU)

(21) Appl. No.: 19/476,737

(22) PCT Filed: Jan. 31, 2024
(86) PCT No.: PCT/RU2024/000023

§ 371 Date: Oct. 20, 2025

(30) Foreign Application Priority Data
Aug. 23, 2023 (RU) 2023121960

(51) Int. Cl. C01C 1/04

(52) U.S. Cl. CPC C01C 1/04

(57) ABSTRACT

In an ammonia synthesis process line that uses natural gas as feedstock, natural gas is subjected to primary and secondary reforming. The resulting converted gas is sent for the conversion of carbon dioxide and the subsequent methanation of the purified synthesis gas, followed by ammonia synthesis. In a fuel line, natural gas and steam are heated and subjected to primary and secondary reforming, the resulting converted gas is sent for the conversion of carbon dioxide and the purified synthesis gas is used in the fuel and process lines. The technical result is that of making it possible to use the entire volume of synthesis gas in a process line for the synthesis of ammonia.

### TECHNICAL FIELD

The invention pertains to ammonia synthesis technologies that use natural gas as feedstock.

### BACKGROUND ART

A conventional method for producing ammonia from natural gas includes a stage, at which natural gas is converted into hydrogen-and nitrogen-containing syngas, and an ammonia synthesis stage, at which the syngas reacts at high pressure to produce ammonia.

At the conversion stage, natural gas is sent to treatment to remove undesirable impurities. The treated gas is then sent to a reforming stage to produce a converted gas containing mostly nitrogen, hydrogen, carbon monoxide (CO), and carbon dioxide (CO₂). The syngas is then sent to the CO conversion stage where carbon monoxide is oxidized to produce carbon dioxide (CO₂). After the carbon dioxide (CO₂) content is removed from the resulting gas mixture, the syngas is sent for methanation, the final purification stage.

At the ammonia synthesis stage, the syngas is compressed and sent to the synthesis stage to produce converted syngas containing mostly ammonia, nitrogen, and hydrogen. The resulting mixture is sent to the ammonia recovery stage.

The most common method for conventional ammonia production from natural gas is reforming, which includes two phases: steam pre-conversion (primary reforming) and secondary conversion of the resulting gas where a mixture of steam and oxygen or a mixture of steam, air, and oxygen is added (secondary reforming). Under this method, the heat required for the primary reforming reaction is generated by combusting some of the natural gas in a reforming furnace. The method also provides for the use of a fired heater to increase the temperature of process fluids and/or generate high-pressure steam for captive use in the ammonia plant.

The above furnaces and fired heaters that conventional ammonia plants comprise are a source of carbon dioxide (CO₂) emissions since they are fuelled by natural gas.

There exists a method for producing ammonia from natural gas, which includes compression, heating, and purifying of natural gas to remove sulfur compounds, two-stage catalytic conversion of methane under pressure, including steam conversion in the first stage and steam and air conversion in the second stage, using the heat from the gas converted in the second stage as well as from additional combustion of natural gas, purge and flash gases at a burner for the purposes of the first conversion stage of the conversion process, catalytic conversion of carbon oxide contained in the converted gas to produce a mixture of nitrogen and hydrogen, removal of carbon dioxide therefrom, removal of oxygen-containing compounds through methanation, compression of the purified mixture of nitrogen and hydrogen, ammonia synthesis in a closed loop, and separation of the resulting ammonia that is further distributed to the user, as well as recovery of the heat from the flues gases and their venting (RU 2445262 C1, publication date: Mar. 20, 2012).

The method drawback is the use of the heat from natural gas, which is combusted at the burner, thus generating carbon dioxide emissions.

A method for producing ammonia from natural gas, which is the closest to the proposed one, features low CO₂ emissions and consists in heating natural gas and steam in a furnace and transforming it in pre-reformers (primary reformers) and autothermal (secondary) reformers into syngas that contains H₂, CO, and CO₂; operating the autothermal reforming on oxygen-rich air or oxygen; converting the syngas in a conversion section and then removing CO₂ in a decarbonization section to produce deleted syngas; using a portion of the deleted syngas to fuel the furnace; treating the remaining deleted syngas in a methanator; adding the nitrogen exiting from an air separation section to the syngas fraction exiting the methanation section and sending the stream to an ammonia synthesis section where ammonia and purge gas are produced; extracting hydrogen from the purge gas and adding the hydrogen to the nitrogen and syngas stream before it is supplied to the ammonia synthesis section; adding the off-gas from the hydrogen extraction section to a portion of the deleted syngas, which is sent to the furnace as fuel; generating a stream of oxygen-rich air or oxygen in the air separation section for the autothermal reforming purposes (RU 2759379 C2, publication date: Nov. 12, 2021).

Since the method does not use natural gas as a fuel, carbon dioxide emissions are low. However, a portion of syngas is used as a fuel instead of ammonia synthesis resulting in a lower production output.

### ESSENCE OF THE INVENTION

A technical problem, which is solved with the proposed method, is production of low-carbon ammonia without reducing the ammonia process line production output.

A technical result of the invention consists in enabling the use of the entire syngas volume in the ammonia synthesis process train.

The technical result is achieved with a method for producing ammonia from natural gas that consists in heating the natural gas and steam in a process line and subjecting them to primary reforming, subjecting the resulting converted gas to secondary reforming that operates on a mixture of steam, air, and oxygen, and then sending converted gas to carbon oxide conversion, removing carbon dioxide from resulting syngas, methanating purified syngas, then synthesizing ammonia, while utilizing a purge gas from the ammonia synthesizing process as a fuel to increase the temperature of the natural gas and steam, meanwhile, according to the invention, in a fuel line, the natural gas and steam are heated and subjected to primary reforming, a resulting converted gas is subjected to secondary reforming using a mixture of steam, air, and oxygen, whereafter a resulting converted gas is sent to carbon oxide conversion, a resulting syngas is purified from carbon dioxide, purified syngas pressure is reduced and a portion of the purified syngas is used as a fuel to heat up the natural gas and steam in the fuel line, while another portion, together with purge gas, is used as a fuel to heat up the natural gas and steam in the process line.

Besides, utilizing heat of the converted gas downstream the secondary reforming for the purposes of the primary reforming in the process line is advisable.

Besides. utilizing heat of the converted gas downstream the secondary reforming for the purposes of the primary reforming in the fuel line is also advisable.

Besides, utilizing the purified syngas, after its pressure has been reduced, as a fuel to generate the steam that is consumed both in the process and in the fuel lines is also preferable.

The technical result is thus achieved by sending the entire volume of the syngas generated in the process line to the ammonia synthesis, while using the separate fuel line to produce low-carbon fuel that enables the CO₂ emissions reduction.

### LIST OF DRAWINGS

FIG. 1 shows the flow diagram of the proposed low-carbon ammonia production method.

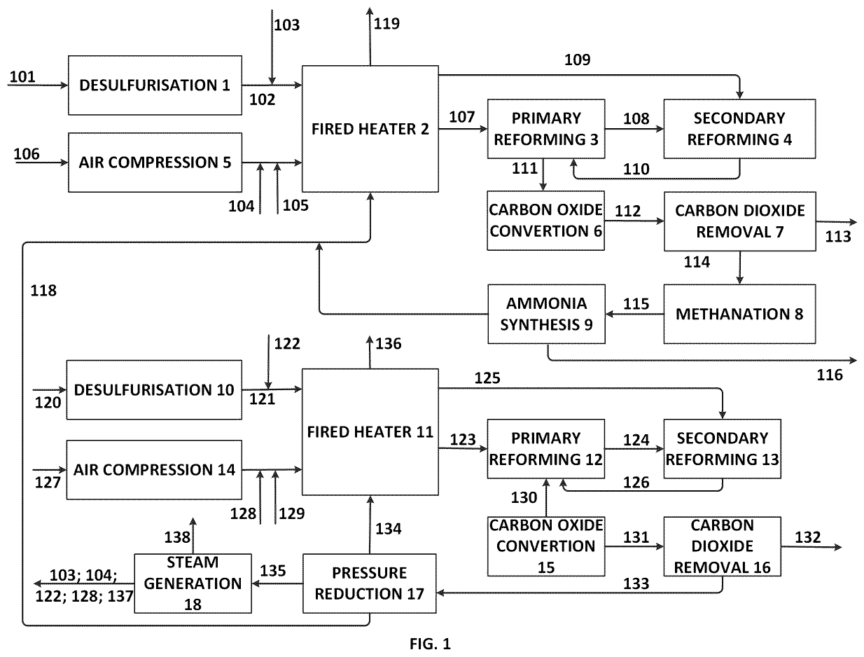

### EXAMPLES OF IMPLEMENTATION OF THE INVENTION

The method for producing ammonia from natural gas, referred to as Ammonia Decarbonized-3000, or AmDec-3000, is implemented as follows.

The flow diagram shown in the drawing separately depicts an ammonia synthesis process line and a fuel line that produces a mixture of nitrogen and hydrogen that is used as a fuel to heat up the process streams.

### Process Line

Natural gas feedstock 101 is suppled to desulfurization line 1 to produce gas that is free from undesirable impurities. Steam 103 is added to purified natural gas 102, which is then sent to fired heater 2. Once heated to the steam reforming reaction point temperature, mixture 107 of steam and gas is sent to reaction tubes of primary reforming reactor 3 where primary reforming occurs utilizing the heat from converted gas 110 exiting from secondary reforming reactor 4. Converted gas 108 is then supplied to secondary reforming reactor 4.

Ambient air 106 is supplied to process air compression line, steam 104 and oxygen 105 are added to the compressed air, which is then fed to fired heater 2. Hot mixture 109 of steam, air, and oxygen is supplied to secondary reforming reactor 4 to produce converted gas mostly containing nitrogen, hydrogen, steam, carbon monoxide, and carbon dioxide.

Converted gas stream 111 is supplied to carbon oxide conversion line 6 where catalytic conversion of carbon monoxide into carbon dioxide, promoted by steam, results in hydrogen generation. Syngas 112 containing carbon dioxide resulting from such conversion is sent to carbon dioxide removal stage 7 based on amine purification. Carbon dioxide 113 removed from the syngas is sent for utilization.

Carbon dioxide depleted syngas 114 is sent to methanation reactor 8 where catalytic conversion of trace amounts of carbon dioxide remaining after carbon dioxide removal stage 7 occurs. Syngas stream 115 is sent to ammonia synthesis line 9 to produce market-grade ammonia 116. Purge gas 117 from ammonia synthesis stage 9 mostly containing nitrogen, hydrogen, and ammonia, is added to carbon-free fuel 118 from the fuel line expander 17. Flue gases 119 from fired heater 2 mostly containing nitrogen and steam are vented.

### Fuel Train

Natural gas feedstock 120 is suppled to desulfurization line 10 to produce gas that is free from undesirable impurities. Steam 122 is added to purified natural gas 121, which is then sent to fired heater 11. Once heated to the steam reforming reaction point temperature, mixture 123 of steam and gas is sent to reaction tubes of primary reforming reactor 12 where primary reforming occurs utilizing heat from converted gas 126 exiting secondary reforming reactor 13. Converted gas 124 is then supplied to secondary reforming reactor 13.

Ambient air 127 is supplied to process air compression line 14, steam 128 and oxygen 129 are added to the compressed air, which is then fed to fired heater 11. Hot mixture of steam, air, and oxygen 125 is supplied to secondary reforming reactor 13 to produce converted gas mostly containing nitrogen, hydrogen, steam, carbon monoxide, and carbon dioxide.

Converted gas stream 130 is supplied to carbon oxide conversion line 15 where catalytic conversion of carbon monoxide into carbon dioxide, promoted by steam, results in hydrogen generation. CO₂-containing syngas 131 resulting from such conversion is sent to carbon dioxide removal stage 16 based on amine treatment. Carbon dioxide 132 removed from the syngas is sent for utilization.

Carbon dioxide depleted syngas 133 mostly containing nitrogen and hydrogen is sent to pressure reducer 17, which may be a choke valve or an expander, where the gas expansion energy is utilized to generate cold and electric power. The resulting low-pressure syngas is intended to be used as fuel. In the proposed design, the syngas fuel is sent to the process line fired heater 2 (stream 118), the fuel line fired heater 11 (stream 134), and the fired heater of steam generation unit 18 (stream 135). Flue gases 136 from fired heater 11 mostly containing nitrogen and steam are vented.

The steam from steam generation package 18 is sent to the process line (streams 103, 104), the fuel line (streams 122, 128), and, if necessary, to external users (stream 137). Flue gases 138 from the fired heater of steam generation unit 18 mostly containing nitrogen and steam are vented.

Because of the removal of carbon dioxide 113, 132 for further utilization coupled with zero carbon dioxide content in the flue gases, CO₂ emissions are limited to less than 0.2 t/t (tonnes of CO₂ per tonne of ammonia product), which is equivalent to more than a 90% CO₂ capture rate.

This low-carbon ammonia method is compatible with processes and plants that produce hydrogen, urea, ammonium sulfate, ammonium chloride, ammonium nitrate, nitrous acid, and other synthetic ammonia derivatives.

1. A method for producing ammonia from natural gas that comprises heating natural gas and steam in a process line and subjecting them to primary reforming, subjecting resulting converted gas to secondary reforming that operates on a mixture of steam, air, and oxygen, and then sending the converted gas to carbon dioxide conversion, purification of resulting syngas from carbon dioxide, methanating purified syngas, then synthesizing ammonia, while utilizing the purge gas generated in ammonia synthesis process as a fuel to increase temperature of the natural gas and steam, wherein in the fuel line, natural gas and steam are heated and subjected to primary reforming, resulting converted gas is subjected to secondary reforming using a mixture of steam, air, and oxygen, whereafter resulting converted gas is sent to carbon dioxide conversion, resulting syngas is purified from carbon dioxide, purified syngas pressure is reduced and a portion of the purified syngas is used as a fuel to heat up the natural gas and steam in the fuel line, while another portion, together with purge gas, is used as a fuel to heat up the natural gas and steam in the process line.

2. The method according to claim 1, wherein in the process train, the primary reforming utilizes the heat from the converted gas downstream the secondary reforming.

3. The method according to claim 1, wherein in the fuel line, the primary reforming utilizes heat from the converted gas downstream the secondary reforming.

4. The method according to claim 1, wherein the purified syngas, after its pressure has been reduced, is used as a fuel to generate the steam that is consumed both in the process and in the fuel lines.
